(19) United States
(12) Patent Application Publication
(10) Pub. No.: US 2008/0028028 A1
(43) Pub. Date: Jan. 31, 2008

(54) E-mail archive system, method and medium

(75) Inventor: Tod Chismark, Port Orange, FL (US)

Correspondence Address: WILMERHALE/DC, 1875 PENNSYLVANIA AVE., NW, WASHINGTON, DC, 20004, US

(73) Assignee: GR8 Practice LLC, Port Orange, FL (US)

(21) Appl. No.: 11/493,642

(22) Filed: Jul. 27, 2006

(51) Int. Cl. G06F 15/16

(52) U.S. Cl. 709/206

(57) ABSTRACT

Embodiments of the present invention provide systems and methods for managing emails in a computer network. According to various embodiments, a method includes receiving and duplicating an email using an email server in the computer network, and, using the email server, storing the duplicated email at a temporary email repository for subsequent retrieval. The method further includes retrieving the duplicated email from the temporary email repository, parsing the duplicated email into a plurality of fields, storing the parsed email in an archive data repository and causing the stored email to be indexed in the archive data repository using at least one of the plurality of fields.

### FIELD OF THE INVENTION

Embodiments of the present invention relate to systems and methods for managing electronic messages (“emails”). More particularly, embodiments of the present invention are related to systems and methods for archiving and retrieving emails in a computer network.

### BACKGROUND OF THE INVENTION

Email has become an integral component of day-to-day communications in today's business environment. With the rapid growth of the use of email, managing emails within an organization has become a challenging task. For many businesses, however, it is desirable or necessary to archive emails instead of discarding them.

For example, following the adoption of Sarbanes-Oxley Act in 2002, archiving emails has become a matter of regulatory compliance for public companies. Other related regulations from the Securities Exchange Commission (SEC), New York Stock Exchange (NYSE), and National Association of Securities Dealers (NASD) also require certain businesses to retain and manage email communication as official business records. Similarly, the Health Insurance Portability and Accountability Act (HIPAA) impose email records management requirements upon healthcare and pharmaceuticals industries. Some states have also adopted public records laws and regulations that require the archival of emails for some organizations.

In addition, organizations not governed by record retention regulations also face the need to archive emails in a manner that allows for easy retrieval at a later time. For example, an organization can be requested by a court or regulatory body to produce certain emails as a part of a legal discovery process. Without a robust email archival/retrieval system, complying with the discovery request can prove to be costly and time consuming. Furthermore, archived emails may also contain valuable corporate knowledge, which can be utilized by a business to gain a competitive advantage.

Conventional email archival systems, however, are often cumbersome to deploy and operate, and can become costly ventures for many organizations. Conventional systems also lack the capability to automatically store various aspects of incoming, outgoing, and intra-organization (or intra-site) email. Embodiments of the present invention are directed to these problems and other important objectives.

### SUMMARY OF THE INVENTION

Embodiments of the present invention provide systems, methods and mediums for reliably archiving contents of emails in a computer network. The archived email contents can later be searched and retrieved in an efficient manner. In some embodiments, the present invention captures all incoming, outgoing, and intra-organization emails in a computer network, parses the emails, and indexes the emails in a data repository for fast retrieval. A conventional email server can be utilized by embodiments of the present invention to capture the emails. Using the present invention, an organization can, e.g., more effectively comply with regulatory requirements with reduced costs.

According to various embodiments, a method can include receiving and duplicating at least one email using an email server in the computer network, and, using the email server, storing the duplicated email at a temporary email repository for subsequent retrieval. The method can further include retrieving the duplicated email from the temporary email repository, parsing the duplicated email into a plurality of fields, storing the parsed email in an archive data repository and causing the stored email to be indexed in the archive data repository using at least one of the plurality of fields. The parsing can be performed at a location distinct from the email server in the computer network, or at the same location as the email server in the computer network. The archive data repository can be maintained in a network file server or a storage area network. In one embodiment, the email server is a Microsoft Exchange Server. The email server can be an email server that has unified messaging capabilities.

In addition, parsing of an email can include one or more of extracting one or more header fields of the email, extracting a plain text body and/or an HTML body of the email, and extracting one or more attachments of the email. Extracting one or more of the header fields can include extracting a blind carbon copy field of the email and obtaining an email address of each recipient contained in the blind carbon copy field of the email.

In some embodiments, the method can further include receiving a search request and searching the archive data repository to find one or more emails stored therein that satisfy the received search request. In addition, upon finding one or more emails satisfying the received search request, the method can include exporting the found emails. The search request can be received through a web interface. Exporting of the found emails can include converting the found emails to PDF format.

According to various embodiments, a system of the present invention can be implemented in a computer for managing emails in a computer network. The system can include a retriever for retrieving at least one email from a temporary email repository in the computer network, a parser for parsing the retrieved email into a plurality of fields, and an indexer for storing the parsed email in an archive data repository and creating indexes for the parsed email in the archive data repository using at least one of the fields. The email is stored in the temporary email repository by an email server in the computer network. The retriever can include an email client. The system can further include an email server that duplicates inbound, outbound, and intra-site emails and stores the emails in the temporary email repository. In one embodiment, the email server is a Microsoft Exchange Server. The email server can be an email server that has unified messaging capabilities.

In some embodiments, the indexer of the system can store the parsed email in an archive data repository maintained in a network file server. Alternatively, the indexer can store the parsed email in an archive data repository maintained in a storage area network. The parser can be configured to extract one or more header fields of the email, a plain text body and/or an HTML body of the email, and/or one or more attachments of the email. The parser can be configured to extract a blind carbon copy field of the email and obtain an email address for each recipient contained in the blind carbon copy field of the email.

In some embodiments, the system can further include an interface component configured to receive a search request and search the archive data repository to find one or more stored emails that satisfy the received search request. The interface component can be further configured to convert the found one or more emails into at least one PDF file. The interface component can include a web server.

According to various embodiments, a computer program product can be embodied in a carrier wave or computer readable medium for managing emails in a computer network. The carrier wave or computer readable medium can cause one or more computers to perform the steps of receiving and duplicating at least one email using an email server in the computer network, and, using the email server, storing the duplicated email at a temporary email repository for subsequent retrieval. The carrier wave or computer readable medium can further cause one or more computers to perform the steps of retrieving the duplicated email from the temporary email repository, parsing the duplicated email into a plurality of fields, storing the parsed email in an archive data repository and causing the stored email to be indexed in the archive data repository using at least one of the plurality of fields. The parsing can be performed at a location distinct from the email server in the computer network, or at the same location as the email server in the computer network. The archive data repository can be maintained in a network file server or a storage area network. In one embodiment, the email server is a Microsoft Exchange Server. The email server can be an email server that has unified messaging capabilities.

In addition, parsing of an email that is caused by the computer program product can include extracting one or more header fields of the email, extracting a plain text body and/or an HTML body of the email, and extracting one or more attachments of the email. Extracting one or more of the header fields can include extracting a blind carbon copy field of the email and obtaining an email address of each recipient contained in the blind carbon copy field of the email.

In some embodiments, the computer program product can further cause the one or more computers to perform the steps of receiving a search request and searching the archive data repository to find one or more emails stored therein that satisfy the received search request. In addition, upon finding one or more emails satisfying the received search request, the computer program product can further cause the one or more computers to exporting the found emails. The search request can be received through a web interface. Exporting of the found emails can include converting the found emails to PDF format.

### BRIEF DESCRIPTION OF THE DRAWINGS

The Detailed Description of the Invention, including the description of various embodiments of the invention, will be best understood when read in reference to the accompanying figures wherein:

FIG. 1 is a diagram illustrating an example flow of emails in a computer network that uses a system according to various embodiments of the present invention;

FIG. 2 is a block diagram illustrating components according to various embodiments of the present invention;

FIG. 3 is a block diagram illustrating an example flow of emails between various components of the system illustrated in FIG. 2;

FIG. 4 is a block diagram illustrating components according to various embodiments of the present invention, including (and/or using) a network file server;

FIG. 5 is a block diagram illustrating components according to various embodiments of the present invention, including (and/or using) a storage area network;

FIG. 6 is a block diagram illustrating components according to various embodiments of the present invention, including (and/or using) an archive data repository;

FIG. 7 is a block diagram illustrating components according to various embodiments of the present invention, including (and/or using) an email server;

FIG. 8 is a block diagram illustrating components according to various embodiments of the present invention, including (and/or using) an email client;

FIG. 9 is a diagram illustrating the retrieval of email content according to various embodiments of the present invention;

FIG. 10 is a diagram illustrating an example flow of email content during the retrieval of archived emails, according to various embodiments of the present invention; and

FIG. 11 is a flow chart illustrating a method for archiving and retrieving email content, according to various embodiments of the present invention.

### DETAILED DESCRIPTION OF THE INVENTION

Embodiments of the present invention provide systems, methods and mediums for archiving emails generated in and/or destined for a computer network of an organization. Systems of the present invention can obtain emails collected by an email server within a computer network, parse the obtained emails, and store the parsed emails for fast retrieval. In some embodiments, a system can also perform searches on the email archive based on user search requests and export the search results for user review or analysis.

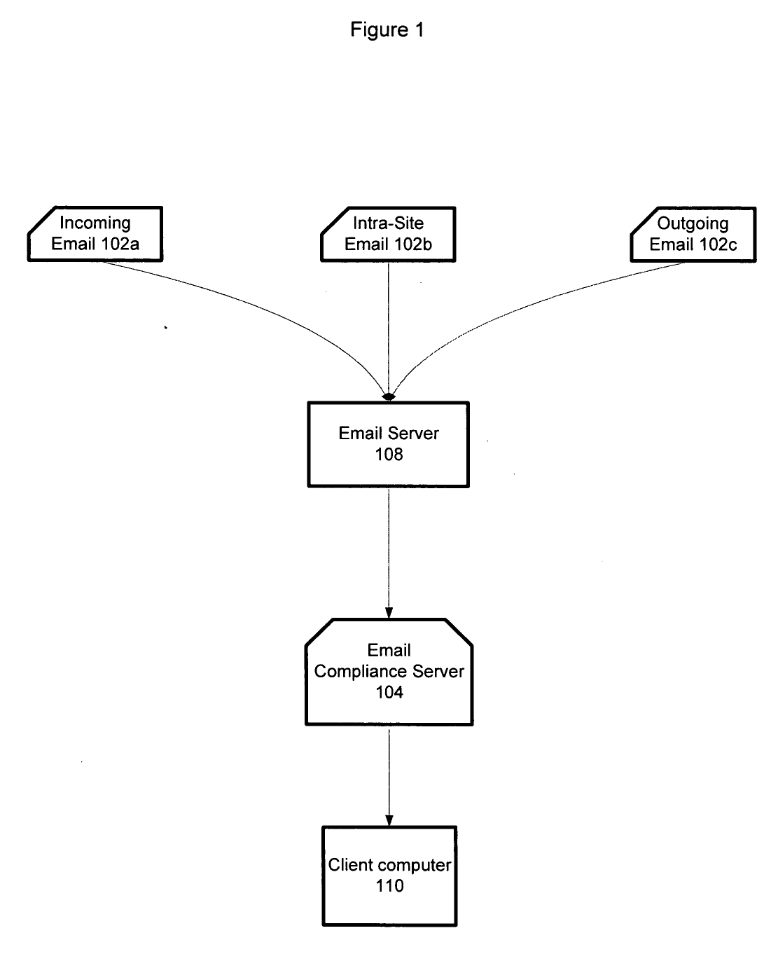

FIG. 1 is a diagram illustrating a flow of email contents within a computer network. As shown, email server 108 receives incoming email 102a (i.e., an email delivered from an outside entity to the computer network), intra-site email 102b (i.e., an email generated by and destined for computers in the computer network), and outgoing email 102c (i.e., an email delivered from the computer network to an outside entity). Email server 108 can be a conventional email server, such as the Microsoft Exchange Server (e.g., Microsoft Exchange Server 2000, Microsoft Exchange Server 2003, or other versions) that controls the distribution of emails in the computer network using the Simple Mail Transfer Protocol (SMTP).

Emails 102a, 102b, and 102c can be any type of electronic message that is received by email server 108. An email server, such as a Microsoft Exchange Server, can have unified messaging capabilities and can interface with various technologies including, but not limited to, Instance Messaging (IM) systems, voice mail systems, fax systems, Short Message Service (SMS) systems, and public folders. Therefore, embodiments of the present invention can be used to receive and archive electronic messages such as instance messages, voice messages, faxes, and/or messages received from other types of systems.

In addition to delivering the received emails (e.g., emails 102a, 102b, and 102c) to the Internet or other computers within the computer network, email server 108 can deliver copies of the emails (e.g., emails 102a, 102b, and 102c) to email compliance server 104, directly or indirectly, as described below. Email compliance server 104 can archive the email copies, so that the contents of the emails can be later retrieved and sent to client computer 110. Client computer 110 can use a software application, for example, a web front-end application, to communicate with email compliance server 104 to retrieve and display emails.

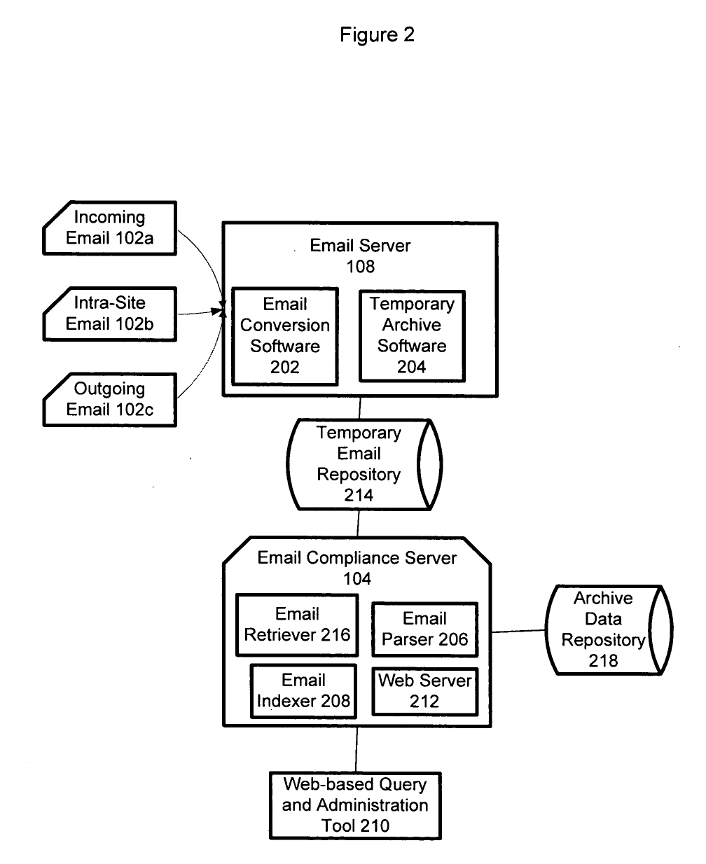

FIG. 2 is a diagram illustrating email compliance server 104 of various embodiments of the present invention, together with email server 108. Email server 108 can include email conversion software 202 that converts received emails (e.g., emails 102a, 102b, 102c) to the Multipurpose Internet Mail Extensions (MIME) messaging format. For every email, email recipients such as mailing lists, distribution groups, and Blind Carbon Copy (BCC) recipients can be expanded to form a list of individual recipients. Email server 108 can then deliver the email to every individual recipient. Email server 108 can also include temporary archive software 204 that duplicates received emails (e.g., emails 102a, 102b, 102c) and stores the duplicated emails at a temporary email repository 214. Compliance server 104 can retrieve emails from temporary email repository 214, parse the emails, and store the parsed emails in archive data repository 218. Compliance server 104 can be implemented using a computer that includes industry standard hardware components and an operating system such as Linux.

Email server 108 can be, for example, a computer installed with Microsoft Exchanges Server software. Temporary archive software 204 can be implemented as a software application plug-in, referred to as an Event Sink, as part of a Message Categorizer module which functions in combination with an Advanced Queuing module within Microsoft Exchange Server. In the Microsoft Exchange Server architecture, an Event Sink can be a user-implemented program that is executed in connection with an SMTP service event. An SMTP service event is the occurrence of some activity within the SMTP service, such as the transmission or arrival of an SMTP command or the submission of a message into the SMTP service transport component. When a particular event occurs, the SMTP service uses an event dispatcher to notify registered Event Sinks of the event. When notifying Event Sinks, the SMTP service passes information to the Event Sink in the form of Component Object Model (COM) object references. Implementation of Event Sinks is described in Writing Managed Sinks for SMTP and Transport Events, Microsoft Corporation, 2003, http://msdn.microsoft.com/library, which is hereby incorporated by reference in its entirety. In this example, an Event Sink program that is associated with the reception of every email can be implemented to duplicate each received email and send the duplicated email to temporary email repository 214, while the Microsoft Exchange Server delivers the email to intended recipients.

Temporary email repository 214 can be used in various embodiments to temporarily store received emails. Repository 214 can be, for example, a network folder accessible through a network file server, or a folder located on email server 108. Email retriever 216 of compliance server 104 can periodically poll repository 214. If repository 214 is not empty, retriever 216 can retrieve and remove emails deposited in repository 214. Temporary email repository 214 ensures that emails received by email server 108 would be archived even if compliance server 104 and/or archive data repository 218 is momentarily shut down or removed from the computer network (e.g., for maintenance purposes). When this happens, emails are stored in temporary email repository 214 until compliance server 104 and/or archive data repository 218 resumes operation in the computer network and starts to retrieve emails from repository 214.

In addition, compliance server 104 can include email parser 206 and email indexer 208. Email parser 206 can parse a retrieved email to extract various fields from the email. For example, for an email that conforms to RFC 822, which is a widely used standard of the format of Internet text messages, various header fields in the email such as Subject, IP address, Date, From, To, CC, and BCC header fields can be extracted. By extracting the To, CC, and BCC header fields, the email address of every recipient of the email can be obtained.

The body of the email can also be extracted, including a plain text email body and/or an HTML email body. One or more attachments included in the email may also be extracted. Extracted email bodies and/or attachments may have been encoded to conform to the MIME format, in which case they can be decoded using information contained in MIME related header fields that can be extracted from the email.

Upon parsing an email, email indexer 208 can permanently store the contents of the email (e.g., email body, attachments, and/or header fields) in archive data repository 218. Apart from saving the parsed email in repository 218, indexer 208 can create indexes using information contained in the extracted fields of the email, so that email contents are archived in a systematic manner and can be efficiently searched and retrieved at a later time.

Repository 218 can include a relational database accessible via a conventional database server. For example, MySQL Community Edition, which is an open source database software, can be used in repository 218. Repository 218 can store emails using various tables and indexes. Data stored in repository 218 can be accessed using stored procedures and triggers that are custom designed to maximize efficiency. Data contained in repository 218 can be encrypted for security and integrity purposes. In addition, a single copy of certain email contents can be stored for multiple emails. For example, if multiple emails contain the same email attachment, repository 218 can store one copy of the email attachment and reference this single copy for each of the emails for later retrieval.

Compliance server 104 may also contain a web server 212 for receiving and serving email search requests from web-based query and administration tool 210. Tool 210 can be a web browser running on a client computer that allows a user to enter a search request. Alternatively, compliance server 104 may contain other types of software (e.g., a command line interface software) that can receive and/or execute email search requests. After receiving a search request from tool 210, compliance server 104 can perform the requested search in repository 218. For example, if repository 218 includes a conventional relational database server, web server 212 can issue search commands in Structured Query Language (SQL) to repository 218. After receiving search results back from repository 218, web server 212 can format the received result and send it to tool 210.

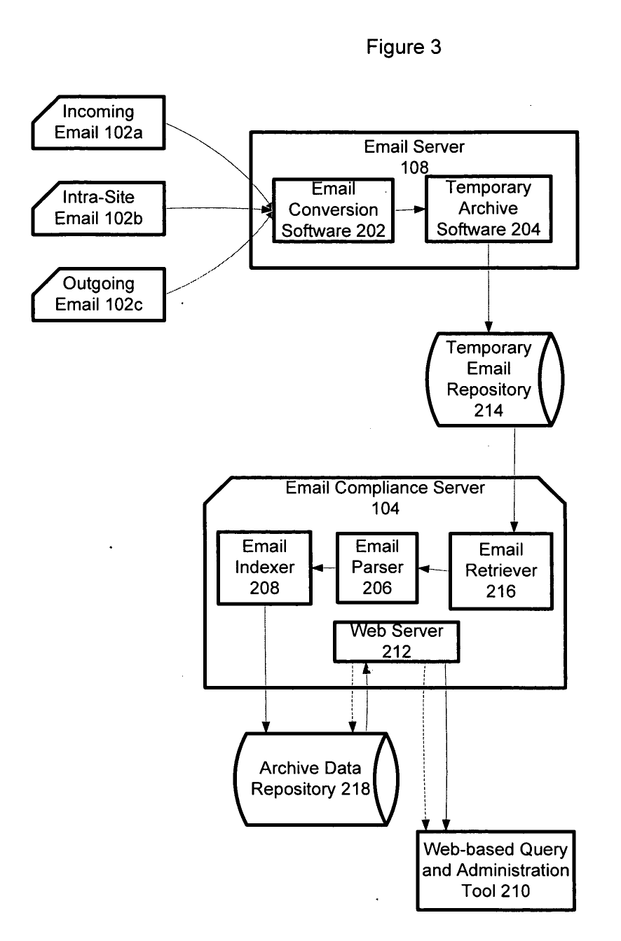

FIG. 3 illustrates an example flow of emails or email contents among components of email server 108, email compliance server 104, and various other systems illustrated in FIG. 2. As shown, incoming email 102a, intra-site email 102b, and outgoing email 102c can all be received by email server 108 and can be processed by email conversion software 202 of email server 108. Before or while delivering the emails 102a, 102b, and 102c to their respective destinations, temporary archive software 204 of server 108 can duplicate the emails and deliver the duplicated emails to temporary email repository 214. Email retriever 216 of compliance server 104 can poll and retrieve emails from repository 214 from time to time, and parser 206 can process the retrieved emails. The parsed email contents can then be archived in archive data repository 218 using email indexer 208. Upon receiving an email search request issued from tool 210, web server 212 of compliance server 104 can search archive data repository 218 and forward the received email contents to tool 210.

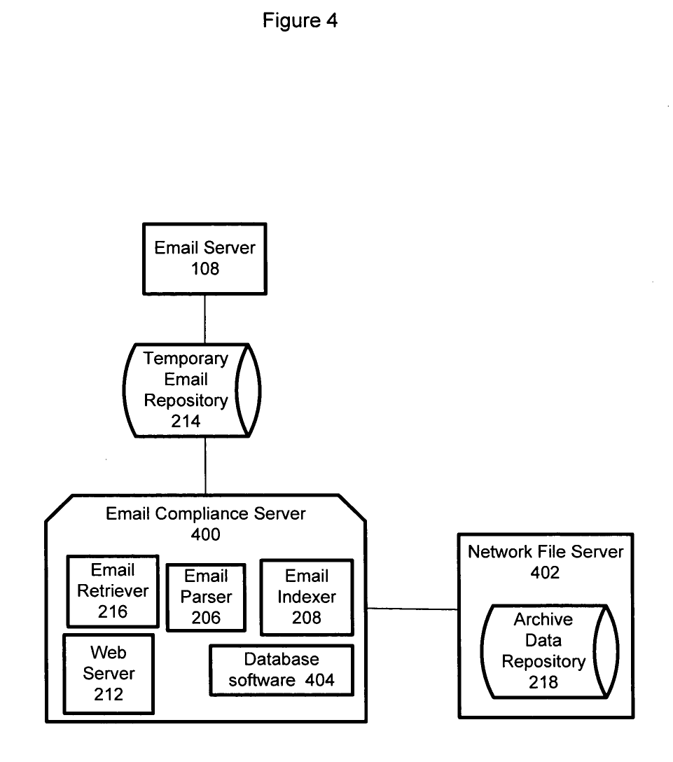

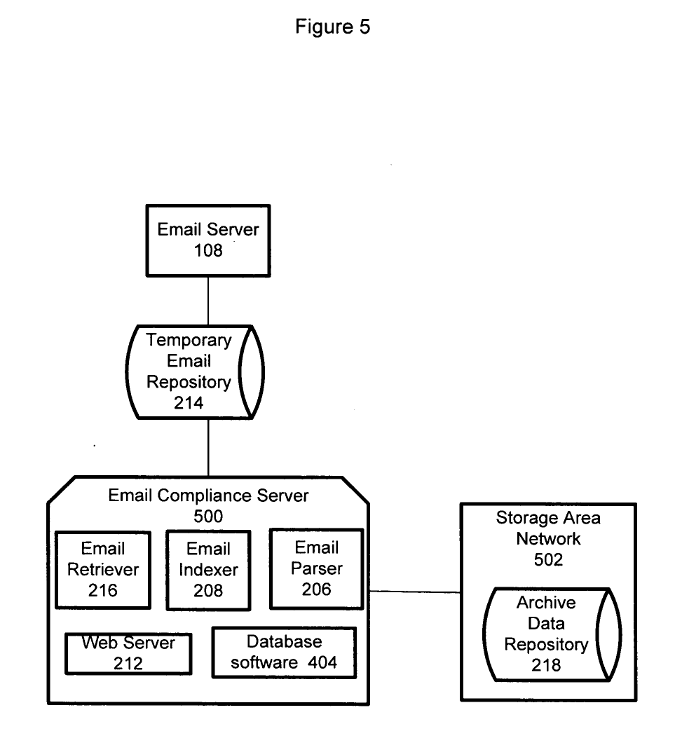

FIGS. 4 and 5 illustrate additional email compliance server embodiments 400 and 500 of the present invention. Similar to compliance server 104 illustrated in FIG. 2, compliance servers 400 and 500 can include email parser 206, email indexer 208, web server 212, and can retrieve emails from temporary email repository 214 using email retriever 216. In addition to server 104 in FIG. 3, compliance servers 400 and 500 include database software 404 for accessing archive data repository 218. Database software 404 can be conventional relational database server software that receives and processes SQL commands. Data repository 218 can be maintained in a network file server 402, as shown in FIG. 4. Network file server 402 can be, e.g., a Linux based file server computer using the open source Samba software. Alternatively, as shown in FIG. 5, data repository 218 can be located and maintained in a storage area network 502. Storage area network 502 can include, e.g., multiple storage devices interconnected using Fibre Channel networking technologies.

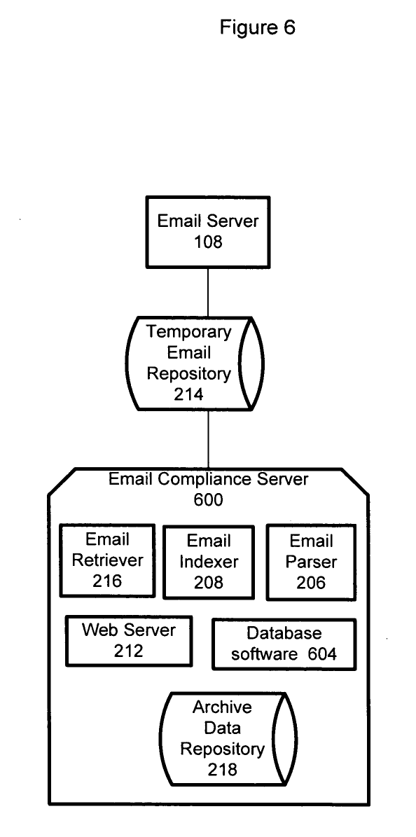

FIG. 6 illustrates an email compliance server 600 of various embodiments of the present invention. Similar to compliance server 104 illustrated in FIG. 2, compliance server 600 can include email parser 206, email indexer 208, web server 212, and can retrieve emails from temporary email repository 214. In addition, compliance server 600 can include a permanent storage wherein archive data repository 218 can be maintained. Compliance server 600 may also include database software 604 for interfacing with archive data repository 218. Hence, compliance server 600 need not communicate with an external email archive as illustrated in FIG. 2.

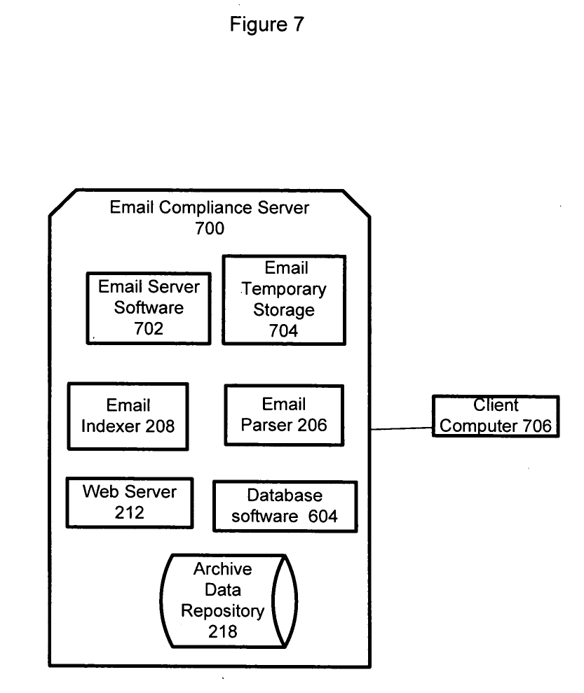

FIG. 7 illustrates an email compliance server 700 of various embodiments of the present invention. Similar to compliance server 600 illustrated in FIG. 6, compliance server 700 can include email parser 206, email indexer 208, web server 212, database software 604, and archive data repository 218. Compliance server 700 also includes email server software 702, so that server 700 can function as a conventional email server in addition to archiving received emails. Furthermore, compliance server 700 may include email temporary storage 704, wherein emails received by server software 702 can be stored temporarily. A client computer 706 can include an email client software for retrieving emails from temporary storage 704, utilizing, for example, version 3 of the Post Office Protocol (“POP3”). Duplicates of received emails can be permanently archived in archive data repository 218 of compliance server 700.

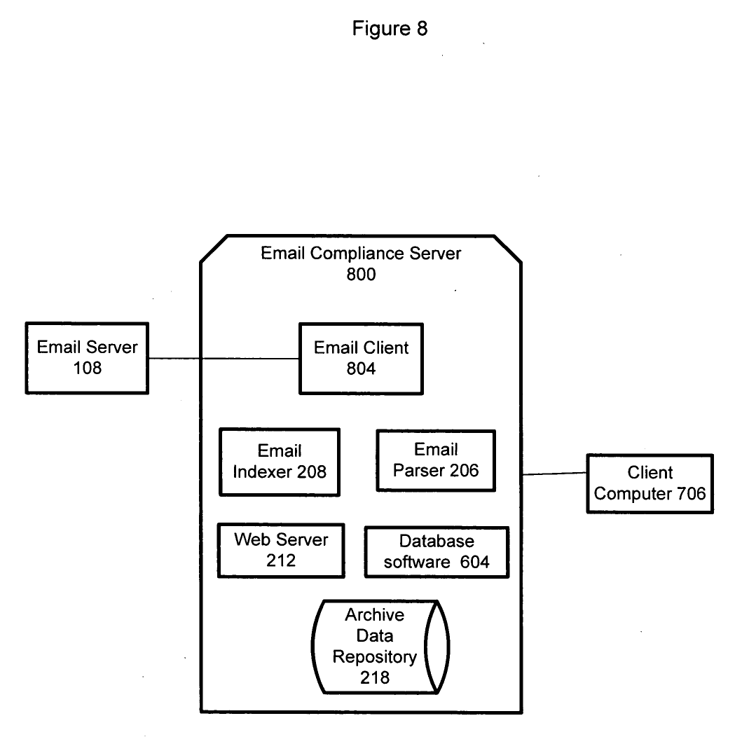

FIG. 8 illustrates an email compliance server 800 of various embodiments of the present invention. Similar to compliance server 600 illustrated in FIG. 6, compliance server 800 can include email parser 206, email indexer 208, web server 212, database software 604, and archive data repository 218. In addition, compliance server 800 includes email client software 804 for retrieving emails from an external email server 108. Email client software 804 can use, for example, POP3 to retrieve emails from email server 108.

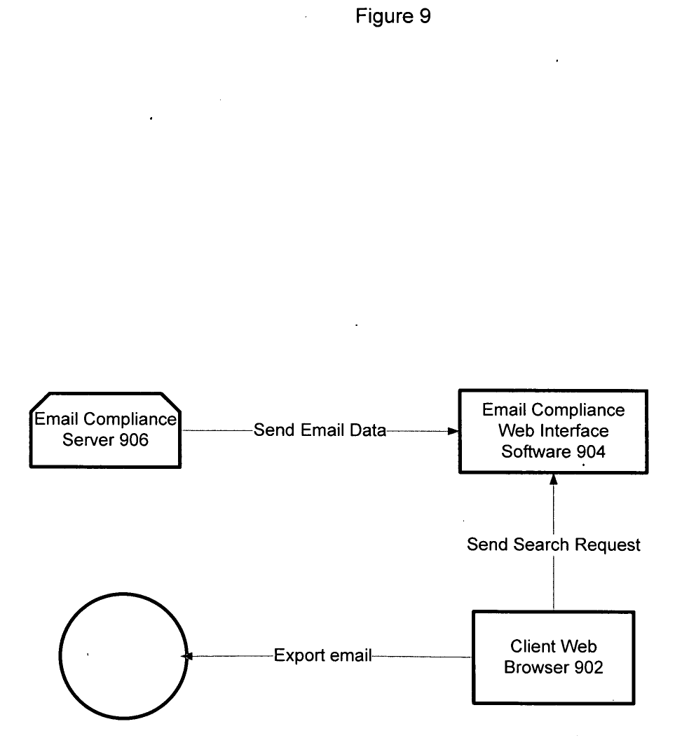

FIG. 9 is a diagram illustrating the retrieval of archived emails using various embodiments of the present invention. Client web browser 902 can allow a user to input a search request and send the search request to email compliance web interface software 904. Interface software 904 may communicate with email compliance server 906 for executing the search request. For example, interface software 904 may generate strings representing SQL search commands and send the search commands to a database server included in compliance server 906. After the search is performed, compliance server 906 may send email contents that result from the search to interface software 904. Email contents can then be forwarded to and presented in client web browser 902. Web browser 902 may further convert the email contents to a standard format, or export the email contents for additional analysis or backup.

Although interface software 904 and compliance server 906 are shown in FIG. 9 as separate entities, interface software 904 may be included in compliance server 906. In addition to email contents, compliance server 906 can maintain and export statistical information, for example, information pertaining to the usage of an archive data repository (not shown) that is associated with compliance server 906. Exported statistical information may be presented in charts or textual reports. To ensure the protection of private information, interface software 904 may require authentication and/or authorization before executing a user request, and may send encrypted data to encryption enabled clients.

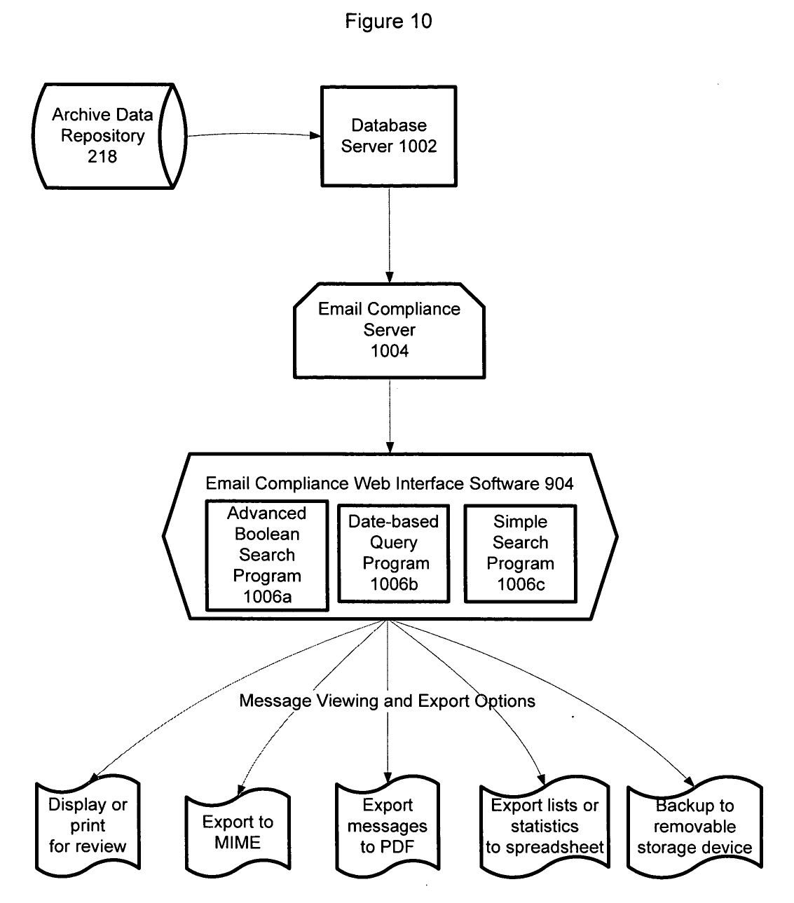

FIG. 10 is a diagram illustrating the flow of email contents during the retrieval of archived emails. During the retrieval process, database server 1002 performs searches on email contents archived in archive data repository 218. Email contents received by database server 1002 can be forwarded to email compliance server 1004 and email compliance web interface software 904. Interface software 904 can include various programs, such as advanced Boolean search program 1006a, date-based query program 1006b, and/or simple search program 1006c. These programs can be, for example, Common Gateway Interface programs that receive user search requests and communicate with compliance server 1004 and database server 1002 to perform searches.

Email contents or statistics received by interface software 904 can be presented to the user in various ways. For example, they can be displayed on screen or printed for user review, converted to the Portable Document Format (“PDF”), or converted to the MIME format. Interface software 904 may also export statistics to spreadsheet software for analysis. In addition, email contents or statistics may be exported to a removable storage device for backup.

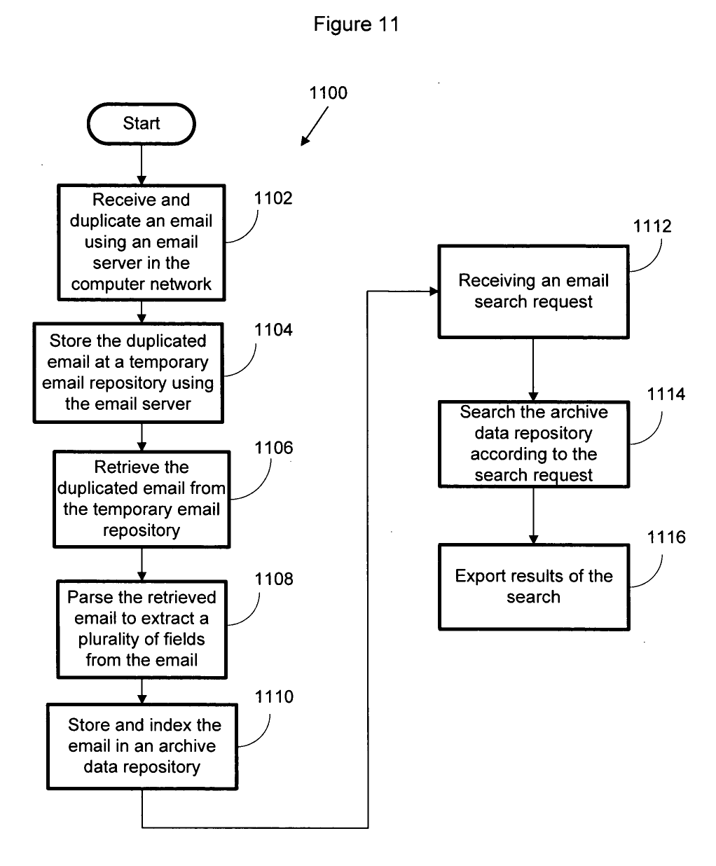

FIG. 11 is a flow chart illustrating a method for archiving and retrieving emails in a computer network, generally at 1 100. At step 1102, an email that enters the computer network or originate from the computer network can be received and duplicated using an email server. At step 1104, the duplicated email can be stored at a temporary email repository using the email server. At step 1106, the stored email can be retrieved from the temporary email repository. At step 1108, the retrieved email can be parsed to extract various fields, including header fields, email body, and/or attachments. At step 1110, email contents that result from the parsing process can be stored in a permanent archive data repository, and indexed using the various extracted fields for fast search and retrieval. At step 1112, user specified email search requests can be received, and at step 1114, the archive data repository can be searched based on the search requests. At step 1116, the results of the search can be exported. For example, the results of the search can be converted to a PDF file and presented on a web browser for user review.

Email compliance servers of various embodiments of the present invention can be clustered and coupled with one or more storage area networks (SANs) for large scale, highly reliable, and extremely expandable storage needs. Embodiments of the present invention can be scaled to meet the requirements of large entities such as large corporations or governments.

It should be appreciated by those skilled in the art that the present invention also contemplates the use of additional (and alternate) steps and/or items not shown in the figures of the application, and that various steps and/or items in the figures may also be omitted. In general, it should be emphasized that the various components of embodiments of the present invention can be implemented in hardware, software, or a combination thereof. In such embodiments, the various components and steps would be implemented in hardware and/or software to perform the functions of the present invention. Any presently available or future developed computer software language and/or hardware components can be employed in such embodiments of the present invention. For example, at least some of the functionality mentioned above could be implemented using Perl, Visual Basic, JavaScript, and/or other programming languages.

It should also be appreciated by those skilled in the art that various embodiments of the present invention may be realized as a computer program product executed on a computer. The computer program product may be stored on a physical medium, or embedded within a carrier wave.

Other embodiments, extensions, and modifications of the ideas presented above are comprehended and within the reach of one skilled in the art upon reviewing the present disclosure. Accordingly, the scope of the present invention in its various aspects should not be limited by the examples and embodiments presented above. The individual aspects of the present invention, and the entirety of the invention should be regarded so as to allow for modifications and future developments within the scope of the present disclosure. The present invention is limited only by the claims that follow.

1. A method for managing emails in a computer network, the method comprising:
receiving and duplicating at least one email using an email server in the computer network;
using the email server, storing the duplicated email at a temporary email repository for subsequent retrieval;
retrieving the duplicated email from the temporary email repository;
parsing the duplicated email into a plurality of fields; and
storing the parsed email in an archive data repository and causing the stored email to be indexed in the archive data repository using at least one of the plurality of fields.

2. The method of claim 1, wherein the parsing is performed at a location distinct from the email server in the computer network.

3. The method of claim 1, wherein the parsing is performed at the same location as the email server in the computer network.

4. The method of claim 1, wherein the archive data repository is maintained in a network file server.

5. The method of claim 1, wherein the archive data repository is maintained in a storage area network.

6. The method of claim 1, wherein the parsing comprises one or more of:
extracting one or more header fields of the duplicated email;
extracting at least one of a plain text body and an HTML body of the duplicated email; and
extracting one or more attachments of the duplicated email.

7. The method of claim 6, wherein extracting one or more of the header fields comprises:
extracting a blind carbon copy field of the duplicated email; and
obtaining an email address of each recipient contained in the blind carbon copy field of the duplicated email.

8. The method of claim 1, further comprising:
receiving a search request;
searching the archive data repository to find one or more emails stored therein that satisfy the received search request; and
upon finding one or more emails satisfying the received search request, exporting the found one or more emails.

9. The method of claim 8, wherein exporting the found one or more emails comprises converting the found emails to PDF format.

10. The method of claim 8, wherein the receiving comprises receiving a search request through a web interface.

11. The method of claim 1, wherein the email server is a Microsoft Exchange Server.

12. The method of claim 1, wherein the email server has unified messaging capabilities.

13. A system, implemented in at least one computer, for managing emails in a computer network, the system comprising:
a retriever for retrieving at least one email from a temporary email repository in the computer network, wherein the at least one email is stored in the temporary email repository using an email server in the computer network;
a parser for parsing the retrieved email into a plurality of fields; and
an indexer for storing the parsed email in an archive data repository and creating indexes for the parsed email in the archive data repository using at least one of the plurality of fields.

14. The system of claim 13, further comprising the email server, wherein the email server is configured to duplicate inbound, outbound, and intra-site emails and stores the emails in the temporary email repository.

15. The system of claim 14, wherein the email server comprises a Microsoft Exchange Server.

16. The system of claim 14, wherein the email server has unified messaging capabilities.

17. The system of claim 13, wherein the indexer is configured to store the parsed email in an archive data repository maintained in a network file server.

18. The system of claim 13, wherein the indexer is configured to store the parsed email in an archive data repository maintained in a storage area network.

19. The system of claim 13, wherein the parser is configured to extract one or more of: header fields of the at least one email, at least one of a plain text body and an HTML body of the at least one email, and one or more attachments of the email.

20. The system of claim 19, wherein the parser is configured to extract a blind carbon copy field of the at least one email and obtain an email address for each recipient contained in the blind carbon copy field of the at least one email.

21. The system of claim 13, further comprising:
an interface component configured to receive a search request and search the archive data repository to find one or more emails stored therein that satisfy the received search request.

22. The system of claim 21, wherein the interface component is further configured to convert the found one or more emails into at least one PDF file.

23. The system of claim 21, wherein the interface component comprises a web server.

24. The system of claim 21, wherein the retriever comprises an email client.

25. A computer program product, embodied in a carrier wave or computer readable medium, for managing emails in a computer network, the carrier wave or computer readable medium causing one or more computers to perform the steps of:
receiving and duplicating at least one email using an email server in the computer network;
using the email server, storing the duplicated email at a temporary email repository for subsequent retrieval;
retrieving the duplicated email from the temporary email repository;
parsing the duplicated email into a plurality of fields; and
storing the parsed email in an archive data repository and causing the stored email to be indexed in the archive data repository using at least one of the plurality of fields.

26. The computer program product of claim 25, wherein the parsing is performed at a location distinct from the email server in the computer network.

27. The computer program product of claim 25, wherein the parsing is performed at the same location as the email server in the computer network.

28. The computer program product of claim 25, wherein the archive data repository is maintained in a network file server.

29. The computer program product of claim 25, wherein the archive data repository is maintained in a storage area network.

30. The computer program product of claim 25, wherein the parsing comprises one or more of:
extracting one or more header fields of the duplicated email;
extracting at least one of a plain text body and an HTML body of the duplicated email; and
extracting one or more attachments of the duplicated email.

31. The computer program product of claim 30, wherein extracting one or more of the header fields comprises:
extracting a blind carbon copy field of the duplicated email; and
obtaining an email address of each recipient contained in the blind carbon copy field of the duplicated email.

32. The computer program product of claim 25, further comprising:
receiving a search request;
searching the archive data repository to find one or more emails stored therein that satisfy the received search request; and
upon finding one or more emails satisfying the received search request, exporting the found one or more emails.

33. The computer program product of claim 32, wherein exporting the found one or more emails comprises converting the found emails to PDF format.

34. The computer program product of claim 32, wherein the receiving comprises receiving a search request through a web interface.

35. The computer program product of claim 25, wherein the email server is a Microsoft Exchange Server.

36. The computer program product of claim 25, wherein the email server has unified messaging capabilities.
